(19) United States
(12) Patent Application Publication
(10) Pub. No.: US 2024/0167181 A1
(43) Pub. Date: May 23, 2024

(54) SYSTEM OF RECOVERING LITHIUM PRECURSOR AND METHOD OF RECOVERING LITHIUM PRECURSOR

(71) Applicant: SK INNOVATION CO., LTD., Seoul (KR)

(72) Inventors: Suk Joon HONG, Daejeon (KR); Hyun Tae BAE, Daejeon (KR); Ji Min KIM, Daejeon (KR); Sang Ick LEE, Daejeon (KR); In Ae LEE, Daejeon (KR)

(21) Appl. No.: 18/493,809

(22) Filed: Oct. 25, 2023

(30) Foreign Application Priority Data
Nov. 18, 2022 (KR) 10-2022-0155832

(51) Int. Cl. C25C 1/02; C25C 7/02; C25C 7/04; H01M 10/54

(52) U.S. Cl. CPC C25C 1/02; C25C 7/02; C25C 7/04; H01M 10/54

(57) ABSTRACT

In a method of recovering a lithium precursor, a first electrode including an active material, and a second electrode are prepared. The first electrode and the second electrode are immersed in a first reaction solution in a first reaction vessel and a second reaction solution in a second reaction vessel, respectively. A voltage or a current is applied to the first electrode and the second electrode to recover a lithium precursor from the active material.

### CROSS-REFERENCE TO RELATED APPLICATION AND CLAIM OF PRIORITY

This application claims priority to Korean Patent Application No. 10-2022-0155832 filed on Nov. 18, 2022, the entire disclosure of which is incorporated by reference herein.

### BACKGROUND

### 1. Field

Embodiments of the present disclosure relate to a system and method of recovering a lithium precursor. More particularly, embodiments of the present disclosure relate to a system and method of recovering a lithium precursor from a cathode active material.

### 2. Description of the Related Art

According to developments of information and display technologies, a secondary battery which can be charged and discharged repeatedly has been widely employed as a power source for a mobile electronic device such as a camcorder, a mobile phone, a laptop computer, etc. Secondary battery examples include lithium, nickel-cadmium, and nickel-hydrogen secondary batteries. The lithium secondary battery is widely used and developed due, at least in part, to its higher operational voltage and energy density per unit weight, higher charge rate, and compact dimensions.

The lithium secondary battery may include an electrode assembly including a cathode, an anode and a separator, and an electrolyte solution impregnating the electrode assembly. The lithium secondary battery may further include an exterior material in the form of, e.g., a pouch, that accommodates the electrode assembly and the electrolyte solution.

A lithium composite oxide may be used as a cathode active material for the lithium secondary battery. The lithium composite oxide may contain a valuable metal. As demand for lithium secondary batteries increases and concerns of environmental pollution are being increased, recycling methods for the cathode active material of lithium secondary batteries are needed.

### SUMMARY

According to an aspect of the present disclosure, there is provided a method of recovering a lithium precursor having improved productivity and efficiency.

According to another aspect of the present disclosure, there is provided a system of recovering a lithium precursor having improved productivity and efficiency.

According to an embodiment of the present disclosure, a method of recovering a lithium precursor may comprise preparing a first electrode including an active material, and a second active material. The method further comprises immersing the first electrode in a first reaction solution in a first reaction vessel and immersing the second electrode in a second reaction solution in a second reaction vessel. A voltage or a current is then applied to the first electrode and the second electrode. The method also comprises recovering a lithium precursor from the active material.

In some embodiments, the preparing of the first electrode may include preparing the first electrode to contain the active material in an active material storing portion thereof or coating the active material on a surface thereof.

In some embodiments, the first electrode may include an active material storing portion at one end thereof in which the active material is accommodated.

In some embodiments, the active material storing portion may have a pouch shape or a basket shape.

In some embodiments, the active material storing portion may be formed of a carbon felt.

In some embodiments, the first electrode may include an electrode bar connected to the active material storing portion.

In some embodiments, the first electrode may include an electrode bar, and the active material may be directly coated on a surface of the electrode bar.

In some embodiments, the first reaction vessel may serve as an oxidation unit, and the second reaction vessel may serve as a reduction unit.

In some embodiments, the first reaction solution may include a lithium ion-containing aqueous solution, and the second reaction solution may include water or a lithium ion-containing aqueous solution.

In some embodiments, the first reaction vessel and the second reaction vessel may be connected to each other by a connection portion including an ion exchange membrane therein.

In some embodiments, the ion exchange membrane may include at least one made of Nafion, Diaion and Trilite.

In some embodiments, wherein the active material may include lithium iron phosphate.

In some embodiments, lithium ions separated from the active material may move to the second reaction vessel to be collected as lithium hydroxide.

According to an embodiment of the present disclosure, a recovery system of a lithium precursor includes a first electrode comprising an active material, a first reaction vessel into which the first electrode is immersed, a second reaction vessel into which a second electrode is immersed, a connecting portion connecting the first reaction vessel and the second reaction vessel and including an ion exchange membrane therein, and a power source applying a voltage or a current to the first electrode and the second electrode.

In some embodiments, the active material may be in the form of a coating on the first electrode or may be contained in an active material storing portion of the first electrode, and the active material may include lithium iron phosphate.

In some embodiments, the first electrode may serve as an oxidizing electrode and the second electrode may serve as a reducing electrode.

According to some embodiments of the present disclosure, a lithium precursor may be recovered through an electrochemical reaction without using an additional additive such as a precipitating agent, an oxidizing agent or a reducing agent. Therefore, yield and productivity of a recovery process may be improved without causing environmental pollution.

According to embodiments of the present disclosure, an active material may be accommodated at an inside of an electrode or may be coated on a surface of the electrode to be introduced into a reaction solution. Therefore, application of an electrical energy to the cathode active material may be performed directly to promote the electrochemical reaction. Additionally, lithium ions may be quickly separated from the cathode active material and iron phosphate may be efficiently recovered.

The lithium precursor recovered according to embodiments of the present disclosure may be reused for a cathode active material and a lithium secondary battery. The lithium secondary battery may be widely applied in green technology fields using a battery such as an electric vehicle, a battery charging station, a solar power generation, a wind power generation, etc. The lithium secondary battery may be used for eco-friendly electric vehicles and hybrid vehicles to prevent climate change by suppressing air pollution, greenhouse gas emission. etc.

These and other features and advantages of embodiments of the present disclosure will become apparent to the skilled person in this art from the following drawings and detailed description.

### BRIEF DESCRIPTION OF THE DRAWINGS

FIG. 1 is a schematic cross-sectional view illustrating a system of recovering a lithium precursor in accordance with some embodiments of the present disclosure.

FIG. 2 is a schematic cross-sectional view illustrating a system of recovering a lithium precursor in accordance with some embodiments of the present disclosure.

FIG. 3 is a schematic cross-sectional view illustrating a first electrode included in a system of recovering a lithium precursor in accordance with some embodiments of the present disclosure.

### DETAILED DESCRIPTION OF THE EMBODIMENTS

According to embodiments of the present disclosure, a method of recovering a lithium precursor is provided which includes an electrochemical reaction (hereinafter, which may be abbreviated as recovery method). According to embodiments of the present disclosure, a system of recovering a lithium precursor (hereinafter, which may be abbreviated as a recovery system) capable of implementing the recovery method is also provided.

Hereinafter, embodiments of the present disclosure will be described in detail with reference to the accompanying drawings. However, those skilled in the art will appreciate that such embodiments and drawings are provided to further understand the spirit of the present invention and do not limit subject matters to be protected as disclosed in the detailed description and appended claims.

The term “precursor” as used herein comprehensively refer to a compound containing a specific metal to provide the specific metal included in an electrode active material.

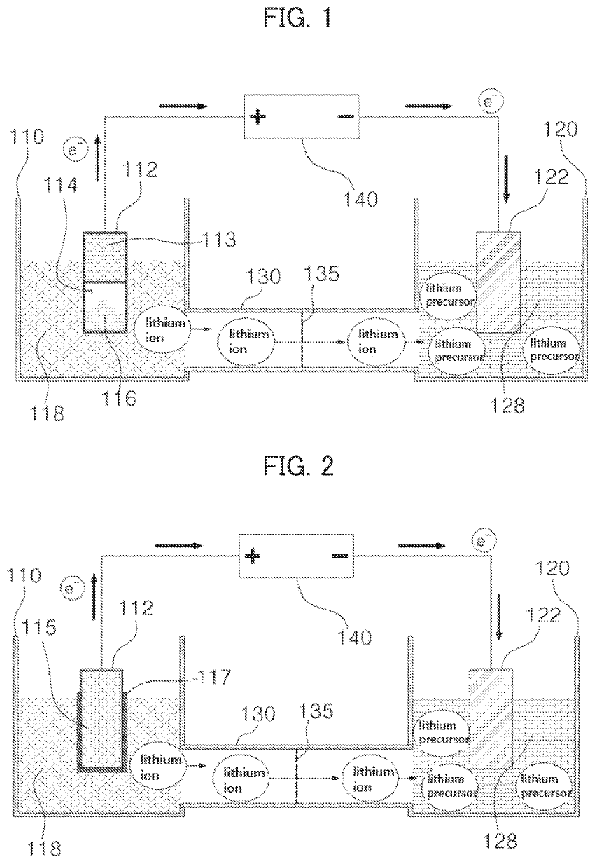

FIG. 1 is a schematic cross-sectional view illustrating a system of recovering a lithium precursor in accordance with some embodiments of the present disclosure. For example, the lithium precursor recovery method according to embodiments of the present disclosure may be implemented using the system of FIG. 1.

Hereinafter, the recovery method of the lithium precursor will also be described with reference to FIG. 1.

Referring to FIG. 1, the recovery system may include a first electrode 112 and a second electrode 122. The first electrode 112 and the second electrode 122 may be introduced into a first reaction vessel 110 and a second reaction vessel 120, respectively.

For example, the first electrode 112 may serve as an oxidizing electrode, and the second electrode 122 may serve as a reducing electrode.

According to some embodiments of the present disclosure, an active material 116 for recovering a lithium precursor may be introduced in the first electrode 112. In some embodiments, the active material 116 may include a cathode active material obtained from a used lithium secondary battery (e.g., a waste lithium secondary battery).

The lithium secondary battery may include an electrode assembly including a cathode, an anode and a separator interposed between the cathode and the anode. The cathode and the anode may include a cathode active material layer and an anode active material layer coated on a cathode current collector and an anode current collector, respectively.

For example, the cathode active material layer may include lithium iron phosphate (e.g., LiFePO₄) as the cathode active material.

The cathode active material may be recovered by separating a cathode from a waste lithium secondary battery. As described above, the cathode may include the cathode current collector (e.g., aluminum (Al)) and the cathode active material layer, and the cathode active material layer may include a conductive material and a binder together with the cathode active material.

The conductive material may include, e.g., a carbon-based material such as graphite, carbon black, graphene or a carbon nanotube. The binder may include a resin material, e.g., vinylidene fluoride-hexafluoropropylene copolymer (PVDF-co-HFP), polyvinylidenefluoride (PVDF), polyacrylonitrile, polymethyl methacrylate, etc.

In some embodiments, the cathode active material may be recovered by pulverizing the recovered cathode. Accordingly, the cathode active material may be recovered as a powder in the form of, e.g., a black powder. In an embodiment, the cathode active material may be recovered in the form of a scrap by peeling the cathode active material layer from the cathode current collector.

The recovered cathode active material may include lithium iron phosphate as described above. In some embodiments, the recovered cathode active material may include a conductive material and/or a binder.

In some embodiments, the recovered cathode active material may be heat-treated prior to an introduction into the recovery system. Impurities such as the conductive material and the binder may be removed or reduced by heat-treatment, and a high-purity cathode active material may be introduced into the recovery system.

The cathode active material applied to the recovery system and recovery method according to embodiments of the present disclosure is not limited to lithium iron phosphate. The recovery system and recovery method of the present disclosure may also be applied to other cathode active materials including, for example, a nickel-based cathode active material.

However, the method is particularly effective with active material containing lithium iron phosphate. It has been found that applying a voltage or a standard reduction potential induces an electrochemical reaction, which makes for an effective recovery of a lithium precursor from an active material containing lithium iron phosphate.

Therefore, hereinafter, embodiments in which the active material 116 includes lithium iron phosphate will be described in detail.

In some embodiments, the first electrode 112 may include an active material storing portion 114 at one end capable of accommodating the active material 116 therein. The first electrode 112 may include an electrode bar 113 connected to the active material storing portion 114. For example, the active material storing portion 114 may be integrally connected to an end of the electrode bar 113.

The electrode bar 113 may have a solid structure, and the active material storing portion 114 may have a hollow structure including a space for accommodating the active material 116.

In a non-limiting example, the active material storing portion 114 may have a pouch shape or a basket shape.

In some embodiments, the active material storing portion 114 may be made of a material that may readily form a hollow structure. Also, the active material storing portion 114 may include a material or a structure that may promote transfer of electrons (e−) separated by an oxidation reaction of the active material 116. In some embodiments, the active material storing portion 114 may have a mesh structure, a felt structure, or a knit structure.

In some embodiments, the active material storing portion 114 may be formed of a carbon felt.

The electrode bar 113 may be formed of a metallic material or a carbon-based material (e.g., a graphite electrode) capable of inducing or promoting the oxidation reaction.

In some embodiments, the electrode bar 113 and the active material storing portion 114 may be formed using the carbon-based material.

The second electrode 122 may serve as an opposing electrode to the first electrode 112.

In a non-limiting example, the second electrode 122 may have a bar shape that has a solid structure entirely.

The second electrode 122 may include a metal or a transition metal that may promote a reduction reaction to obtain electrons (e−). For example, the second electrode 122 may include at least one of copper, nickel, titanium, aluminum and an alloy thereof. In an embodiment, the second electrode 122 may include a carbon-based electrode.

As described above, the first electrode 112 and the second electrode 122 may be introduced into the first reaction vessel 110 and the second reaction vessel 120, respectively. In some embodiments, a first reaction solution 118 and a second reaction solution 128 may be included in the first reaction vessel 110 and the second reaction vessel 120, respectively.

In some embodiments, the first electrode 112 and the second electrode 122 may be immersed into the first reaction solution 118 and the second reaction solution 128, respectively.

In some embodiments, the first electrode 112 and the second electrode 122 may be partially immersed into the first reaction solution 118 and the second reaction solution 128, respectively. For example, 10% to 90% of a total volume of each of the first electrode 112 and the second electrode 122 may be impregnated into the first reaction solution 118 and the second reaction solution 128.

In some embodiments, 20% to 70%, or 40% to 60% of the total volume of each of the first electrode 112 and the second electrode 122 may be impregnated. Within the above range, transfer of electrons and/or lithium ions and the oxidation/reduction reaction rate in each reaction vessel 110 and 120 occurring by applying voltage or current, which will be described later, may be promoted.

In some embodiments, the active material storing portion 114 included in the first electrode 112 may be entirely immersed in the first reaction solution 118, and the electrode bar 113 may be partially immersed in the first reaction solution 118.

The first reaction solution 118 may include a lithium ion (Li⁺)-containing aqueous solution. The lithium ion-containing aqueous solution may serve as an aqueous electrolyte solution. The second reaction solution 128 may include water or a lithium ion-containing aqueous solution.

The recovery system may include a connection portion 130 that connects the first reaction vessel 110 and the second reaction vessel 120 to each other.

An ion exchange membrane 135 may be disposed within the connection portion 130. In some embodiments, the ion exchange membrane 135 may include an ion exchange resin capable of selectively moving cations.

The ion exchange membrane 135 may include, e.g., an ion exchange resin such as perfluoro sulfonic acid polymer (e.g., NAFION available by the Chemours Company), or DIAION available from Mitsubishi Chemical Company, or TRILITE available from Samyang Corporation, and the like, and may preferably include NAFION.

The recovery system may include a power source 140. The first electrode 112 and the second electrode 122 may be electrically connected to each other through the power source 140 and an external conductor.

A voltage or a current may be directly applied between the first electrode 112 and the second electrode 122 by the power source 140. Accordingly, an electrochemical reaction may be promoted in the recovery system, and a redox reaction may be induced.

The applied voltage may be set in consideration of a standard reduction potential value in the oxidation and reduction reactions. The standard reduction potential refers to a potential measured in a battery constructed by combining a standard hydrogen electrode and a half cell where the reduction occurs.

The recovery system may be operated in a similar manner to that of an electrolytic cell. Reactions that may occur in the recovery system may be represented by Reaction Schemes 1 to 3 below.

Li⁺(aq)+e−+FePO₄(s)↔LiFePO₄(s), E^{o}(V)=0.46 [Reaction Scheme 1]

Li⁺(aq)+H₂O(l)↔LiOH(aq)+H⁺(aq) [Reaction Scheme 2-1]

2LiOH(aq)+CO₂(g)↔Li₂CO₃(aq)+H₂O(l) [Reaction Scheme 2-2]

O₂(aq)+4H⁺(aq)+4e⁻↔2H₂O(l),E^{o}(V)=1.23,E(V)=1.23−0.059×pH [Reaction Scheme 3]

For example, an oxidation reaction may occur at the first electrode 112, and a reduction reaction may occur at the second electrode 122. The oxidation reaction may be defined as a reaction that loses an electron, and the reduction reaction may be defined as a reaction that gains an electron.

A reverse reaction (the oxidation reaction) of Reaction Scheme 1 may occur at the first electrode 112, and a forward reaction (the reduction reaction) of Reaction Scheme 3 may occur at the second electrode 122. The applied voltage or current may be set to reflect a difference between standard reduction potential values of Reaction Scheme 1 and Reaction Scheme 3, and may be set to reflect a pH of the solution.

The E^{o} value in Reaction Scheme 1 and Reaction Scheme 3 may refer to the standard reduction potential in the forward reaction of each Reaction Scheme. The E value in Reaction Scheme 3 may refer to the reduction potential according to the pH of the second reaction solution 128.

For example, the second reaction solution 128 may include a lithium ion-containing aqueous solution and may have a pH of 10. In this case, the E value in Reaction Scheme 3 may be 0.64 (=1.23−0.059×10), and a voltage of 0.3V to 1.0V, or 0.4V to 0.8V may be applied to the recovery system through the power source 140.

An electrochemical reaction may be induced in the above voltage range. For example, if the applied voltage is less than 0.3V, the electrochemical reaction may not be induced because the voltage for the redox reaction may not be sufficient. If the applied voltage exceeds 1.0V, an excess amount of electrical energy may be used and consumed without promoting the redox reaction, which may degrade energy efficiency and reduce productivity.

In some embodiments, the lithium ions (Li⁺) separated from the active material 116 may be transferred to the second reaction vessel 120 to be collected as a lithium precursor (e.g., lithium hydroxide (LiOH) or lithium carbonate (Li₂CO₃).

As expressed in the reverse reaction of Reaction Scheme 1, the oxidation reaction may occur in the first electrode 112 to separate the lithium ions (Li⁺) and electrons (e⁻).

The generated lithium ions (Li⁺) may be dissolved in the first reaction solution 118, and may exist in a state of an aqueous solution. As described above, the first reaction solution 118 may include the lithium ion-containing aqueous solution. The lithium ion-containing aqueous solution may function as an aqueous electrolyte solution. The dissolved lithium ions may be transferred in the first reaction solution 118, and may also be transferred via the connection portion 130.

The lithium ions may also pass through the ion exchange membrane 135. Cations may selectively pass through the ion exchange membrane 135, and thus only the lithium ions (Li⁺) may be transferred while limiting movement of solvent (e.g., water (H₂O)).

For example, when the voltage or the current is applied through the power source 140, the oxidation reaction may occur at the first electrode 112, so that the lithium ions (Li⁺) may be dissolved in the first reaction solution 118, and the separated electrons (e−) may move toward the second reaction vessel 120 through the external conductor connected to the power source 140. To maintain an electrical neutrality of the recovery system, the lithium ions (Li⁺) may move from the first reaction vessel 110 to the second reaction vessel 120 through the connection portion 130 and the ion exchange membrane 135.

As described above, the second reaction solution 128 may include water or the lithium ion-containing aqueous solution. The recovery system may be open to the air. For example, may be operated in an air atmosphere. In the second reaction solution 128, gaseous carbon dioxide (CO₂) present in the air may be dissolved, and carbon dioxide (CO₂) may be present in a state of an aqueous solution.

The lithium ions transferred to the second reaction vessel 120 may react with the second reaction solution 128. In the second reaction vessel 120, the forward reaction of Scheme 2-1 and/or the forward reaction of Scheme 2-2 may occur. Within the second reaction vessel 120, the lithium ions may be converted into a lithium precursor by the forward reactions, and the lithium precursor may be collected within the second reaction vessel 120.

The electrons (e⁻) separated by the oxidation reaction at the first electrode 112 may move from the first electrode 112 to the second electrode 122 by an influence of the voltage or the current applied from the power source 140. The electrons (e⁻) and hydrogen ions (H⁺) generated and dissolved by the forward reaction of Reaction Scheme 2-1 may cause the forward reaction (reduction reaction) of Reaction Scheme 3.

The lithium precursor may be recovered by the forward reaction of Reaction Scheme 2-1 and/or Reaction Scheme 2-2.

The recovery method performed by applying the recovery system may further include drying the second reaction solution 128. In this case, a lithium precursor powder may be recovered.

The lithium ions (Li⁺) and electrons (e⁻) may be separated by the reverse reaction of Reaction Scheme 1, iron phosphate (FePO₄) derived from the active material 116 may remain in the active material storing portion 114. For example, iron phosphate (FePO₄) may remain in a solid state. Therefore, the above-described recovery system may also efficiently recover iron phosphate (FePO₄).

An additional additive such as a precipitating agent, an oxidizing agent and a reducing agent may not be used in the above-described recovery system. Additionally, the recovery system may be operated using only electrical energy and may not cause environmental pollution.

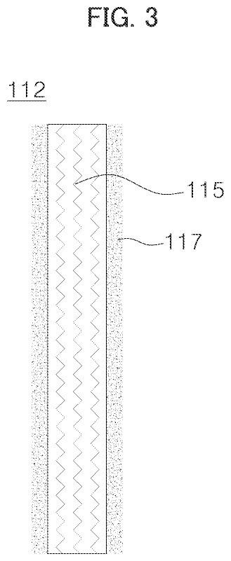

FIG. 2 is a schematic cross-sectional view illustrating a system of recovering a lithium precursor in accordance with some embodiments of the present disclosure. FIG. 3 is a schematic cross-sectional view illustrating the first electrode 112 included in a system of recovering a lithium precursor in accordance with some embodiments of the present disclosure.

Detailed descriptions of elements and operations substantially the same as or similar to those described with reference to FIG. 1 are omitted herein. For example, detailed descriptions of the active material, the second electrode 122 and the mechanism of the redox reaction occurring in the recovery system are omitted.

Referring to FIGS. 2 and 3, the first electrode 112 may have a shape of a single electrode bar 115. For example, the active material storing portion 114 described with reference to FIG. 1 may be omitted from the first electrode 112.

For example, an oxidation reaction may occur in the first electrode 112, and the electrode bar 115 is formed of a metal material (e.g., aluminum (Al)) or a carbon-based material capable of inducing or promoting the oxidation reaction.

In some embodiments, an active material 117 may be coated on a surface of the first electrode 112. In an embodiment, the active material 117 may be directly coated on the electrode bar 115 in the first electrode 112. The ‘direct coating’ may refer to a case that any further material is not formed between the active material 117 and the surface of the first electrode 112.

Electrons (e) separated from the active material 117 may be transferred via the first electrode 112. The active material 117 may be directly coated on the surface of the first electrode 112, so that the electrons (e) may be generated intensively through the first electrode 112.

The active material 117 may at least partially cover the surface of the first electrode 112. For example, the active material 117 may be continuously and uniformly distributed on the surface of the first electrode 112 and may exist in the form of a film covering at least a portion of the surface. In this case, a contact area between the active material 117 and the first electrode 112 may be increased so that transfer of the electrons (e−) separated from the active material 117 may be facilitated through the external conductor, and the redox reaction may be further promoted. Thus, the recovery rate of the lithium precursor may be improved.

In some embodiments, the active material 117 may be discontinuously distributed on the surface of the first electrode 112. For example, the active material 117 may exist in the form of an island in a local area of the outer surface of the first electrode 112.

The active material may be formed using a coating method well known in the related art. For example, the active material 117 may be applied to the surface of the first electrode 112 as a thin film shape in a slurry state.

Hereinafter, various embodiments are proposed to more concretely describe the present invention. However, the following examples are only given for illustrating the present invention and those skilled in the related art will obviously understand that various alterations and modifications are possible within the scope and spirit of the present disclosure. Such alterations and modifications are duly included in the appended claims.

### EXAMPLES AND COMPARATIVE EXAMPLES

### Example 1

A first reactor immersing a first electrode which was a carbon electrode having a pouch-shaped space formed therein was installed. A carbon felt electrode as a second electrode was impregnated into the second reactor.

A power source was connected to both impregnated electrodes, and the first reactor and the second reactor were connected, and an ion exchange membrane containing Nafion was disposed between the reactors.

0.5 g of lithium iron phosphate (LiFePO₄) was prepared as a waste cathode active material, and introduced into an active material storing portion in the first reactor. The first reactor was filled with a 0.1M lithium hydroxide (LiOH) solution impregnating the first electrode, and the second reactor was filled with distilled water impregnating the second electrode.

Thereafter, a current of 10 mA was applied to the power source connected to the first electrode and the second electrode, and a electrochemical reaction proceeded for 4 hours.

### Example 2

An electrochemical reaction proceeded by the same method as that in Example 1, except that a current of 20 mA was applied.

### Comparative Example

10 g of a phosphorus-based cathode active material powder containing LiFePO₄ with a lithium content of 4.4 wt %, 1000 ml of 0.2 mol/L phosphoric acid aqueous solution, and 0.1 g of an iron powder with an average particle size of 30 μm were placed in a reactor and stirred at room temperature for 4 hours to be dissolved therein.

After the dissolution, unreacted residues and solid components such the iron powder were separated by filtration, and caustic soda was added to the filtrate to adjust a pH to 9. Residual iron component remaining in the solution was precipitated in the form of hydroxide, and only a lithium component remained in the solution. The precipitate was separated through a filtration, and the solution and ethanol were mixed at a volume ratio of 1:4. The mixture of the solution and ethanol was stirred at room temperature for 30 minutes. A lithium phosphate precipitate (Li₃PO₄) was generated, and the product was separated through a filtration. Thereafter, the product as washed with ethanol and dried to prepare high purity lithium phosphate as a final product.

### Experiment Example

(1) Evaluation on Li Concentration in Lithium Iron Phosphate (LiFePO₄)

In each Example, a weight percent of lithium ions in lithium iron phosphate (LiFePO₄) present in the first electrode before and after the experiment was measured by an ICP-OES (Inductively Coupled Plasma Optical Emission Spectroscopy).

In a Comparative Example, a weight percent of lithium ions in lithium iron phosphate (LiFePO₄) before and after the experiment was measured by ICP-OES.

The analyzed results are listed in Table 1 below.

(2) Evaluation of Lithium Recovery Ratio

A lithium recovery ratio is defined by Equation 1 below based on a Li concentration in lithium iron phosphate (LiFePO₄).

Lithium recovery rate (%)={(Li concentration in lithium iron phosphate (LiFePO₄) before reaction−Li concentration in lithium iron phosphate (LiFePO₄) after reaction)/Li concentration in lithium iron phosphate (LiFePO₄) before reaction}×100 [Equation 1]

The analyzed results are listed in Table 1 below.

TABLE 1

| | Li concentration in | Li concentration in | |
|---|---|---|---|
| | lithium iron phosphate | lithium iron phosphate | lithium |
| | (LiFePO₄) before | (LiFePO₄) after | recovery |
| | reaction (wt %) | reaction (wt %) | ratio (%) |
| Example 1 | 4.5 | 0.7 | 83.3 |
| Example 2 | 4.5 | 0.1 | 97.8 |
| Comparative | 4.4 | 1.33 | 69.8 |
| Example | | | |

Referring to Table 1, the Li concentration in lithium iron phosphate (LiFePO₄) in Examples was explicitly decreased compared to that in the Comparative Example.

Based on the above results, it can be confirmed that the lithium precursor was produced with high purity using an electrochemical method.

Additionally, in the lithium precursor recovery, the lithium precursor was recovered without an additional additive such as an oxidizing agent, a reducing agent or a precipitating agent and without an additional separation process.

Thus, according to embodiments of the present disclosure, an eco-friendly lithium precursor recovery was implemented using only an electrical energy. Further, iron phosphate (FePO₄) was also recovered from the active material. Moreover, the embodiments may be combined to form additional embodiments.

What is claimed is:

1. A method of recovering a lithium precursor, the method comprising:
preparing a first electrode to include an active material, and a second electrode;
immersing the first electrode and the second electrode in a first reaction solution in a first reaction vessel and a second reaction solution in a second reaction vessel, respectively; and
applying a voltage or a current to the first electrode and the second electrode to recover a lithium precursor from the active material.

2. The method of claim 1, wherein the preparing of the first electrode includes preparing the first electrode to contain the active material in an active material storing portion thereof or coating the active material on a surface thereof.

3. The method of claim 1, wherein the first electrode comprises an active material storing portion at one end thereof in which the active material is accommodated.

4. The method of claim 3, wherein the active material storing portion has a pouch shape or a basket shape.

5. The method of claim 4, wherein the active material storing portion is formed of a carbon felt.

6. The method of claim 3, wherein the first electrode comprises an electrode bar connected to the active material storing portion.

7. The method of claim 1, wherein the first electrode comprises an electrode bar, and the active material is directly coated on a surface of the electrode bar.

8. The method of claim 1, wherein the first reaction vessel serves as an oxidation unit, and the second reaction vessel serves as a reduction unit.

9. The method of claim 8, wherein the first reaction solution comprises a lithium ion-containing aqueous solution, and the second reaction solution includes water or a lithium ion-containing aqueous solution.

10. The method of claim 9, wherein the first reaction vessel and the second reaction vessel are connected to each other by a connection portion including an ion exchange membrane therein.

11. The method of claim 10, wherein the ion exchange membrane includes at least one made of NAFION, DIAION and TRILITE.

12. The method of claim 1, wherein the active material comprises lithium iron phosphate.

13. The method of claim 12, wherein lithium ions separated from the active material move to the second reaction vessel to be collected as lithium hydroxide.

14. A recovery system of a lithium precursor, the recovery system comprising:
a first electrode comprising an active material;
a first reaction vessel into which the first electrode is immersed;
a second reaction vessel into which a second electrode is immersed;
a connecting portion connecting the first reaction vessel and the second reaction vessel and including an ion exchange membrane therein; and
a power source applying a voltage or a current to the first electrode and the second electrode.

15. The recovery system of claim 14,
wherein the active material is in the form of a coating on the first electrode or is contained in an active material storing portion of the first electrode, and
wherein the active material comprises lithium iron phosphate.

16. The recovery system of claim 15, wherein the first electrode comprises an electrode bar connected to the active material storing portion.

17. The recovery system of claim 14, wherein the first electrode serves as an oxidizing electrode and the second electrode serves as a reducing electrode.

18. The recovery system of claim 14, wherein the first electrode comprises an active material storing portion at one end thereof in which the active material is accommodated.

19. The recovery system of claim 18, wherein the active material storing portion has a pouch shape or a basket shape.

20. The recovery system of claim 19, wherein the active material storing portion is formed of a carbon felt.
